(19) United States
(12) Patent Application Publication
(10) Pub. No.: US 2004/0118688 A1
(43) Pub. Date: Jun. 24, 2004

(54) Transparent polymer support for electrophoresis and electrochromatography and related methods

(76) Inventor: David P. Dumas, San Diego, CA (US)

Correspondence Address: McDERMOTT, WILL & EMERY, 7th Floor, 4370 La Jolla Village Drive, San Diego, CA, 92122, US

(21) Appl. No.: 10/630,628

(22) Filed: Jul. 29, 2003

Related U.S. Application Data
(60) Provisional application No. 60/399,889, filed on Jul. 29, 2002.

(51) Int. Cl. G01N 27/26; G01N 27/27

(52) U.S. Cl. 204/548; 204/600; 204/610

(57) ABSTRACT

The invention provides polyol (allyl carbonate) polymer for electrokinetic devices. The devices can be modified for attachment of a chemical moiety or ligand. The electrokinetic devices can be used for a variety of applications, including chemical analysis, biochemical analysis, cell sorting, purification, analytical devices, diagnostic devices, and tissue culture applications. The invention also provides methods of using the polyol (allyl carbonate) polymer electrokinetic devices. The invention also provides for a sensor that allows for the detection of various chemicals, biochemicals, ions, metals, solvents, and bio-polymers.

### BACKGROUND OF THE INVENTION

This application claims benefit of the filing date of U.S. Provisional Application No. 60/399,889, filed Jul. 29, 2002, and which is incorporated herein by reference.

The present invention relates generally to electrokinetic devices and more specifically to electrokinetic devices constructed from polymers having useful optical and chemical resistance properties. The present invention also discloses useful methods and sensors for use with electrokinetic devices.

Capillary electrophoresis (CE) is an electrophoretic separation technique where sample components move under the influence of the electrical field through a capillary tube or channel. High-resolution separations are achieved with CE as a result of the large surface-to-volume ratios that afford rapid heat dispersion generated from Joule heating. Thus, capillaries can tolerate voltages far higher than those used for conventional electrophoresis systems. This translates into significant savings in time and increased separation efficiencies. CE is most often carried out in fused silica capillaries where under normal buffer conditions the silanol groups on the walls of the capillaries are ionized. The surface charge of the capillary is neutralized by buffer components. In the presence of an electrical field, the silanol groups are immobile but the neutralizing buffer components migrate toward the electrode having an opposite charge. As a result, there is a net migration of species within the capillary that may cause the migration of neutral species and some negatively charged species toward the anode. This flow is said to be caused by the electroosmotic force (EOF). The magnitude of the EOF is dictated by the zeta potential, that is, the difference in electrical potential of the capillary surface and the boundary layer of buffer. The chemical composition of the capillary wall, the pH and ionic strength of the buffer solution, and the temperature all play a role in the magnitude of the zeta potential. In addition to its generation of the EOF, analyte molecules may stick to the surface of an ionized capillary through ionic interactions. Non-specific ionic interactions are particularly problematic with protein solutions.

Many capillary electrophoresis methods have been described including:

Capillary Zone electrophoresis (CZE), also known as free solution CE (FSCE), is the simplest form of CE. The separation mechanism is based on differences in the charge to mass ratio of the analytes. The separation relies principally on the pH-controlled ionization of the analyte and the friction of the ionized analyte as it migrates through the buffer solution.

Micellar Electrokinetic Capillary Chromatography (MECC OR MEKC) is a mode of electrokinetic chromatography in which surfactants are added to the buffer solution at concentrations that form micelles. The separation principle of MEKC is based on a differential partition between the micelle and the solvent. This principle can be employed with charged or neutral solutes and may involve stationary or mobile micelles. Micelles can bind analytes through electrostatic interactions mediated by the exposed head groups of the surfactant as well as have hydrophobic interaction with core of the micelle. Sodium dodecyl sulfate (SDS), an anionic detergent, is the most widely used surfactant in MECC. EOF pulls SDS micelles toward the cathode, but electrophoresis tugs these negatively charged aggregates in the opposite direction. The overall result is that SDS micelles move toward the cathode, but at a reduced velocity compared to the bulk flow of the buffer. Analytes can partition between the slower moving micelles and the faster moving, surrounding buffer. The stronger the interaction, the longer a given analyte interacts with the micelle, and the longer its migration time. Alternative anionic surfactants, cationic surfactants, nonionic surfactants, and bile salts may also be used. The selectivity of MECC can be controlled by the EOF, the choice of surfactant, and modifiers like organic solvents added to the buffer. Some molecules that do not form micelles can be used in separations that involve the same basic principles governing MECC. For example cyclodextrins may be used in lieu of micelles.

Affinity capillary electrophoresis (ACE) separates molecules based upon changes that occur when macromolecules bind their ligands. These interactions may be in free solution or by partition between the solution and solid phase. The solid phase may include ligands immobilized on the capillary wall, on beads packed in the capillary, or even incorporated in micelles. Examples of ACE include antigen/antibody, lectin/sugar, drug/protein, and enzyme/substrate complexes. The equilibrium constant of complex formation can be determined by measuring ligand/macromolecule migration time as a function of ligand concentration. ACE can also help determine binding stoichiometries.

Capillary isoelectric focusing (CIEF) allows amphoteric molecules, such as proteins, to be separated by electrophoresis in a pH gradient generated between the cathode and anode. A solute will migrate to a point where its net charge is zero. At this isoelectric point (the solute's pI), migration stops and the sample is focused into a tight zone. CIEF is frequently used for high-resolution separations of proteins and polypeptides, as well as for pI determinations. CIEF may be achieved by mixing the analyte and carrier ampholytes and applying the sample to the capillary. Basic and acidic buffers occupy the reservoirs at the cathode and anode, respectively. An electric field is applied across the capillary, and the ampholytes establish a pH gradient. Each analyte migrates until it encounters a region in which the pH is equivalent to its pI. The EOF must be suppressed for effective CIEF. CIEF may also be achieved by the generation of an immobilized ampholyte gradient along the surface of the capillary.

Isotachophoresis (ITP) is a focusing technique based on the migration of the sample components between leading and terminating electrolytes. Analytes are sandwiched between a leading electrolyte, which must have mobility greater than any cations present in the analyte and a terminating electrolyte which is selected to have a mobility lower than any cation in the sample. Once the electric field has been applied the sample components begin to separate and arrange themselves in order of decreasing mobility. Once the separation is completed, and a steady state obtained, all electrolyte and sample ions migrate at the same velocity. Solutes having mobilities intermediate to those of the leading and terminating electrolytes stack into sharp, focused zones. Although it is used as a mode of separation, transient ITP has been used primarily as a concentration technique prior to CZE separation. Isotachophoresis (ITP) requires the suppression of EOF and employs a heterogeneous buffer system.

Capillary Gel Electrophoresis (CGE) is the adaptation of traditional gel electrophoresis into the capillary using polymers in solution as a molecular sieve. This allows analytes having similar charge to mass ratios to be resolved by size. EOF is suppressed in these techniques. This suppression is often achieved directly by using high viscosity polymer formulations or by using coated capillaries in conjunction with low viscosity matrices. As is the case with slab based methods, gel and polymer network based CE can be performed in the presence of denaturants such as SDS and urea.

Capillary Electrochromatography (CEC) is a hybrid separation method that couples the high separation efficiency of CZE with liquid chromatography using an electric field rather than hydraulic pressure to propel the mobile phase through the capillary. Since there is minimal backpressure, it is possible to use small diameter packings and achieve very high efficiencies. Alternatively, the capillary surface itself may self as the solid phase. Separation is achieved by both electrophoretic mobility and partitioning between the stationary and mobile phases.

Electrokinetic Chromatography (EKC) is a family of electrophoresis techniques named after electrokinetic phenomena, which include electroosmosis, electrophoresis and chromatography. A key example of this is seen with cyclodextrin mediated EKC. Here the differential interaction of enantiomers with the cyclodextrins in combination with an electrophoretic field allows for the separation of chiral compounds.

Nonaqueous Capillary Chromatography (NACE) involves the separation of analytes in a medium composed of organic solvents. The viscosity and dielectric constants of organic solvents affect both sample ion mobility and the level of electroosmotic flow. The use of nonaqueous medium allows additional selectivity options in methods development and is also valuable for the separation of water insoluble compounds.

Dielectrophoresis (DEP) is the movement of a material or an object caused by a spatially non uniform electrical field. Distinct from electrophoresis, DEP only arises when the object has a different tendency to become electrically polarized relative to its surroundings. If the object is more polarizable than its surroundings, it will be pulled towards higher field regions (“positive DEP”); conversely it will be repelled towards weak field regions (“negative DEP”) if it is less polarizable. Positive DEP is known to most of us as the attraction of uncharged bits of paper to a charged plastic comb. Magnetophoresis is the magnetic analog of dielectrophoresis, the collection of magnetically polarizable particles in a spatially non uniform magnetic field. This force is responsible for the familiar collection of iron filings at the fringing fields at the edges of a magnetic pole. Far from being restricted to electrostatic fields, DEP also occurs in alternating (AC) fields even at optical frequencies. An example is when laser tweezers are used to trap a cell having a higher refractive index (larger electronic polarizability) than its suspending medium at the high field gradient focal region of the laser beam (There is also a second, light pressure term in this extreme case). At lower frequencies DEP can be used to impose forces on cells that depend on their low frequency spectral properties. Differences in these spectral properties can be exploited to impose different or even opposing forces on different cell types in a cell mixture.

Fused silica capillaries modified with coatings of certain types, for example cationic surfactants, can be used in applications that call for EOF toward the anode. Methods employing anode directed electroosmosis are often referred to as “EOF reversal” techniques. Various approaches to modifying or masking the EOF generated within a capillary have been reported. These include surface modification of the fused silica capillaries, the use of polymer capillaries, and the modification of buffer components and conditions. These methods are unsatisfactory due to the instability of surface coatings, the limited chemical functional groups that may be generated with polymers, and the incompatibility of analytes to buffer changes. Thus there is a need for an improved support material for capillary electrokinetic applications.

Microchip electrophoresis platforms emerged when the effort towards miniaturization of capillary electrophoresis was achieved in 1992 by Manz et al. (Manz, A., D. J. Harrison, E. M. J. Verpoorte, J. C. Fettinger, A. Paulus, H. Ludi, and H. M. Widmer. 1992. “Planar chips technology for miniaturization and integration of separation techniques into monitoring systems-capillary electrophoresis on a chip.” J. Chromatogr. 593:253-258.) Although the principle of the electrophoresis assay remains unchanged, the microchip system is drastically different from its parental capillary system. On the microchip platform, the separation channels and the sample injection channels, as well as sample preparation and/or pre or post column reactors, can all be micro-fabricated on a planar substrate sealed with a cover plate; therefore, manipulation of multiple functions could be achieved on a single platform. To perform a separation, an injection voltage of several hundred volts is first applied across the sample and sample waste reservoirs to migrate the sample to the injection cross. A separation voltage is then applied to the separation channel, which induces separation of the analyte zones before they reach the detection window several centimeters downstream from the injection cross. Protein analysis constitutes an area of tremendous interest that is waiting to be fully addressed by microchip electrophoresis. The typical characteristic with microchip electrophoresis separations is high speed, normally 4 to 10 fold faster than conventional CE. If parallel processing is performed, then the sample analysis throughput is further increased. Other advantages with microchips are simplicity, the capability of integrating multiple functions, and potential automation.

The successful implementation of UV absorbance detection in microchip systems is hampered by path length issues that severely limit sensitive detection. While extraordinary approaches have yielded success, this is not likely to become popular until some simple and efficient form of light coupling becomes available. Consequently, a number of approaches for detecting proteins have been reported in the literature, all involving fluorescent detection of target proteins. These include serum protein analysis (Colyer, C. L., S. D. Mangru, and D. J. Harrison (1997) “Microchip-based capillary electrophoresis of human serum proteins” J. Chromatogr. A 781:271-276; Koutny, L. B., D. Schmalzing, T. A. Taylor, and M. Fuchs (1996) “Microchip electrophoretic immunoassay for serum cortisol” Anal. Chem. 68:18-22; Schmalzing, D., L. B. Koutny, T. A. Taylor, W. Nashabeh, and M. Fuchs (1997) “Immunoassay for thyroxine (T4) in serum using capillary eletrophoresis and micromachined devices” J. Chromatogr. B 697:175-180.) and fluorescent dye labeled model protein separations Liu, Y. J., R. S. Foote, S. C. Jabobson, R. S. Ramsey, and J. M. Ramsey (2000) “Electrophoretic separation of proteins on a microchip with noncovalent postcolumn labeling” Anal. Chem. 72:4606-4613; Yao, S., D. S. Anex, W. B. Caldwell, D. W. Arnold, K. B. Smith, and P. G. Schultz. (1999) “SDS capillary gel electrophoresis of proteins in microfabricated channels” Proc. Natl. Acad. Sci. USA 96:5372-5377.). The use of fluorescence detection methods requires the use of chemical reporter molecules attached to the analyte. As a result, fluorescent methods require extra processing steps and suffer from inconsistencies. Electrochemical detection has been reported for some molecules. While electrochemical detection eliminates the need for labeling, this method has only limited applicability to molecules that may readily be oxidized or reduced. A more generally applicable detection method has been described based upon the electrical impedance or resistance of molecules as they move between two electrodes (A. Berthold, L. Nicola, P. M. Sarro, M. J. Vellekoop, G. Pignatel (1999) “All-Glass Microstructures for Biochemical Analysis Systems” Eurosensors 13, The 13^{th} European Conference of Solid State Sensors, 975-978; R. M. Guijtl, E. Baltussenl, G. van der Steen1, H. Frank, H. Billiet, T. Schalkhammer, F. Laugere, M. Vellekoop, A. Berthold, L. Sarro, G. W. K. van Dedem (2001) “Capillary electrophoresis with on-chip four-electrode capacitively coupled conductivity detection for application in bioanalysis” Electrophoresis, 22, 2537-2541; J. A. Fracassi de Silva and C. L. do Lago (1999) “Conductivity Detector for Aliphatic Alcohols” Electrophoresis, 21, 1405-1408. M. Galloway, W. Stryjewski, A. Henry, S. M. Ford, S. Llopis, R. L. McCarley, and S. A. Soper (2002) “Contact Conductivity Detection in Poly(methyl methacylate)-Based Microfluidic Devices for Analysis of Mono- and Polyanionic Molecules” Anal. Chem., 74, 2407-2415). While the reported conductivity detectors used with capillary electrophoresis demonstrate the perturbation of electrical properties as a viable detection method, the reported sensitivity is inadequate for most analytical applications. Thus there remains a need for an improved electrical based detection method.

Among the tools frequently employed for tools for proteomics include 2-D gel electrophoresis and mass spectroscopy. These techniques have severe limitations in reproducibility and poor detection thresholds. Among the shortcomings of 2-D gel electrophoresis is that it is virtually impossible to pour two identical polyacrylamide gels. As a result, comparisons between two gels is problematic. Standard proteomics techniques require the staining of proteins in a 2-D electrophoresis gel, comparing the protein pattern to a control gel, excising the protein band of interest and analyzing the band by mass spectroscopy. It would be of tremendous value to the whole field of proteomics to have an electrophoresis device that provides reproducible results, provides quantification, ease of automation, and can be interfaced directly with a mass spectrometer. A 2-D capillary electrophoresis device has been reported in U.S. Pat. No. 6,214,191 where a glass plate has a first channel intersected by multiple parallel secondary channels each orthogonal to the first channel. A protein mixture, pre-labeled with a fluorescent tag, is applied to the first electrophoresis channel where separation is effected based upon the size and charge of the protein. At a given time, voltage is applied to the secondary channels causing the proteins to migrate into secondary channel in closest proximity to the proteins. Isoelectric focusing effects separation in the secondary channel. This system suffers in design as a result of the glass construction where many proteins may interact in a non-specific fashion with the capillary walls; the use of charge-to-mass based separation in the first dimension causes band broadening of the proteins due to diffusion effects ultimately causing low resolution; the requirement for initial labeling of the protein mixture adds a handling step as well as skewing data in favor of those proteins most favorably labeled. Other 2-D capillary methods that have been described require fraction handling between each dimension or in cases where there is automated injection of samples into a single second dimension channel, there is poor resolution and a limited number of proteins that may be analyzed (U.S. Pat. Nos. 6,277,259, 5,916,428, 5,496,460, 5,389,221, 5,240,577, 5,131,998) Thus there is a need for a 2-D capillary-based protein separation method that provides high-resolution separation of large numbers of proteins and a minimum number of handling and processing steps.

The separation of cells and biological samples is routinely achieved in the laboratory using large, expensive flow cytometers, Coulter counters, or laborious manual sorting methods. The detection of biological threat agents, infectious agents, and purity analysis, however, is best performed outside of the laboratory at the site of analysis. Thus there is a need for a rapid and accurate cell-sorting device that is mobile and ideally hand-held.

### SUMMARY OF THE INVENTION

The invention provides polyol (allyl carbonate) polymer for electrokinetic devices. The devices can be modified for attachment of a chemical moiety or ligand. The electrokinetic devices can be used for a variety of applications, including chemical analysis, biochemical analysis, cell sorting, purification, analytical devices, diagnostic devices, and tissue culture applications. The invention also provides methods of using the polyol (allyl carbonate) polymer electrokinetic devices. The invention also provides for a sensor that allows for the detection of various chemicals, biochemicals, ions, metals, solvents, and bio-polymers.

### BRIEF DESCRIPTION OF THE DRAWINGS

FIG. 1 shows an example of an electrokinetic device.

FIG. 2 shows a 2-D device of the invention.

FIG. 3 shows a detector that can be used in an electrophoresis or electrochromatography device.

FIG. 4 shows a null point detection system that can be used as a detector.

FIG. 5 shows a differential amplifier that can be used to amplify the sensitivity of the null point detector.

### DETAILED DESCRIPTION OF THE INVENTION

The invention provides polyol (allyl carbonate) polymer electrokinetic devices having properties useful for a variety of applications, including chemical synthesis, and methods of making and using the electrokinetic devices. The electrokinetic devices of the invention are advantageous in that they have high clarity, low intrinsic fluorescence, resistance to a variety of chemical solvents, and can be chemically modified to allow attachment of a chemical moiety. Thus, the electrokinetic devices of the invention are especially useful in the analysis of biochemical and chemical samples.

As used herein, a “ligand” refers to a molecule that can specifically bind to a binding partner. The term specifically means that the binding interaction is detectable over non-specific interactions by a quantifiable assay. A ligand can be essentially any type of molecule such as a peptide or polypeptide, nucleic acid or oligonucleotide, carbohydrate such as oligosaccharides, an organic derived compound, or an inorganic derived compound.

As used herein, the term “polypeptide” refers to a peptide, polypeptide or protein of two or more amino acids. A polypeptide can also be modified by naturally occurring modifications such as post-translational modifications, including phosphorylation, lipidation, prenylation, sulfation, hydroxylation, acetylation, addition of carbohydrate, addition of prosthetic groups or cofactors, formation of disulfide bonds, proteolysis, assembly into macromolecular complexes, and the like.

A modification of a peptide can also include non-naturally occurring derivatives, analogues and functional mimetics thereof generated by chemical synthesis. Derivatives can include chemical modifications of the polypeptide such as alkylation, acylation, carbamylation, iodination, or any modification that derivatizes the polypeptide. Such derivatized molecules include, for example, those molecules in which free amino groups have been derivatized to form amine hydrochlorides, p-toluene sulfonyl groups, carbobenzoxy groups, t-butyloxycarbonyl groups, chloroacetyl groups or formyl groups. Free carboxyl groups can be derivatized to form salts, methyl and ethyl esters or other types of esters or hydrazides. Free hydroxyl groups can be derivatized to form O-acyl or O-alkyl derivatives. The imidazole nitrogen of histidine can be derivatized to form N-im-benzylhistidine. Also included as derivatives or analogues are those polypeptides which contain one or more naturally occurring amino acid derivatives of the twenty standard amino acids, for example, 4-hydroxyproline, 5-hydroxylysine, 3-methylhistidine, homoserine, ornithine or carboxyglutamate, and can include amino acids that are not linked by peptide bonds.

As used herein, the term “nucleic acid” or “oligonucleotide” means a polynucleotide such as deoxyribonucleic acid (DNA) or ribonucleic acid (RNA). A nucleotide incorporated into an oligonucleotide can be a naturally occurring nucleotide or non-naturally occurring nucleotide, including derivatives thereof such as phosphoramidates and the like. Such derivatized molecules include analogs of adenosine, substituted adenosines, ethenoadenosine, guanosine, substituted guanosines, inosine, substituted inosines, uridine, 5,6-dihydrouridine, substituted uridines, cytodine, substituted cytodines, thymidine, substituted thymidines, and the like. Derivatized molecules also include glycosylated derivatives of purines, pyrimidines, imidazoles, pyridines, pyrollopyrimidines, pyrazallopyrimidine, pyroles, and other nitrogen containing heterocycles. Derivatized molecules also include modifications of the sugar group to include pentoses, substituted pentoses, deoxy-pentoses, hexoses, substituted hexoses, deoxy-hexoses, and the like.

As used herein, the term “oligosaccharide” refers to polymers of monosaccharides that can be linear or branched. Oligosaccharides include modifications of monosaccharides. As used herein, the term “organic molecule” refers to organic molecules that are chemically synthesized or are natural products. As used herein, the term “inorganic molecule” refers to inorganic molecules that are chemically synthesized or are natural products.

As used herein, a “polyol (allyl carbonate)” polymer refers to a polymerizate of organic composition based on a radically polymerizable monomer represented by the general formula:

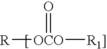

where R is a polyol having two or more hydroxyl groups and R₁ is an allyl or substituted allyl group. Polyol (allyl carbonate) polymers useful in the invention include homopolymers or copolymers that include mono-functional allyl carbonates, diol bis(allyl carbonates), triol tris(allyl carbonates), tetra kis(allyl carbonates), higher polyol (allyl carbonates), and the like.

As used herein, an “electrokinetic device” refers to any device used to allow the separation or migration of a chemical entity by electromotive forces. For example, an electrokinetic device can make use of Capillary Zone electrophoresis (CZE), Free Solution Capillary Electrophoresis (FSCE), Micellar Electrokinetic Capillary Chromatography (MECC OR MEKC), Affinity capillary electrophoresis (ACE), Capillary isoelectric focusing (CIEF), Isotachophoresis (ITP) Capillary Gel Electrophoresis (CGE), Capillary Electrochromatography (CEC), Electrokinetic Chromatography (EKC), Nonaqueous Capillary Chromatography (NACE), Dielectrophoresis (DEP), or other electrophoresis, electrochromatography, or electrokinetic methods known to those skilled in the art.

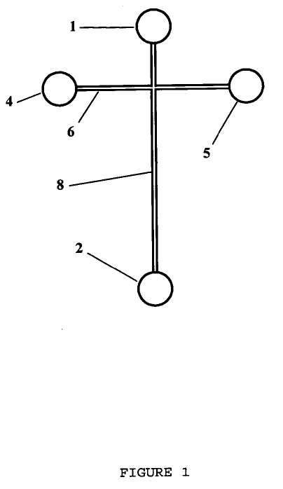

An example of an electrokinetic device is depicted in FIG. 1. Typically, the microchannels 6 and 8 would be covered with a faceplate while the reservoirs 1, 2, 4, and 5 would be exposed by way of through ports in the faceplate. Referring to this figure, buffer is applied to reservoirs 1 and 2 and the separation channel 8. The analyte sample buffer is applied to sample reservoir 4, the sample microchannel 6 and the waste reservoir 5. The analyte sample is applied in the sample reservoir 4 and drawn through the sample microchannel 6 either through the generation of a pressure differential between reservoirs 4 and 5 or by applying an electric potential to the sample microchannel 6 by way of insertion of electrodes into reservoirs 4 and 5, and applying a potential for a desired period of time. Following introduction of the sample into microchannel 6, an electrical potential is applied to the separation microchannel 8 by way of electrodes placed in reservoirs 1 and 2. The sample components are detected by some optical, electrical, electromagnetic, or other detection scheme localized in or around the end of the separation microchannel 6 near the waste reservoir 2. Different electrokinetic methods of separation or migration are affected by means of the nature of the buffer, the sample, the electrical potentials used, and the chemical properties of the separation microchannel 8. This figure is intended to provide a general format of an electrokinetic device and is not intended to be exclusive of the many advantageous designs and formats that are known to those skilled in the art.

As used herein, “immobilized,” “immobilizing,” and other grammatical forms refers to the stable attachment to an electrokinetic device of a chemical moiety such as a ligand. A ligand or chemical moiety can be immobilized via covalent or non-covalent interactions so long as the attached molecule is stable under the conditions of use of the electrokinetic device. For example, if the use of the electrokinetic device involves washing with a solvent to remove unattached chemical moieties, an immobilized chemical moiety remains attached to the electrokinetic device in the wash conditions used for a particular purpose. One skilled in the art can readily determine whether a chemical moiety remains immobilized to an electrokinetic device using well known methods of detecting the presence of a chemical moiety. Such methods can involve directly testing for the presence of a chemical moiety on an electrokinetic device or the removal or cleavage of the ligand or chemical moiety from the electrokinetic device to test for its presence, if desired, as exemplified below (see Example IV).

The invention provides a polyol (allyl carbonate) polymer support in a variety of configurations, particularly those suitable for electrophoresis and electrochromatography. Polymers of allyl carbonate have particularly useful optical properties in that they are colorless and clear. Such polymers of polyol (allyl carbonate) are also abrasion, chemical, heat, and radiation resistant. Polymers of allyl carbonate have found use as transparent coatings, optical lenses, optical lens blanks, other optical elements, and transparent flat and curved sheets. Polymers cast from diethylene glycol bis(allyl carbonate) monomers can be fabricated using standard machining operations, and cast sheets can be hot formed into a variety of shapes.

One problem associated with the polymerization of polyol (allyl carbonate)-functional monomer compositions is the relatively high shrinkage of the material that occurs during the course of polymerization to the final thermoset polymer. For example, there is a shrinkage of approximately 13 percent during the polymerization of diethylene glycol bis(allyl carbonate). Such high shrinkages are particularly detrimental in casting operations where the liquid monomer composition is introduced into a mold and thereafter polymerized to the final thermoset polymer.

It is known that introducing a liquid prepolymer into the mold and thereafter polymerizing the prepolymer to the final thermoset polymer results in a decrease in shrinkage in the mold. The prepolymer is usually produced by partially polymerizing the polyol (allyl carbonate)-functional monomer composition to consume a portion of the allylic groups. For example, the prepolymer can comprise diethylene glycol bis(allyl carbonate), which is partially polymerized. The partial polymerization is stopped before more than a trivial amount of gellation occurs so that the prepolymer can be introduced into the mold as a liquid. The partially polymerized liquid polymer has about 20 to 50% allylic utilization and is a syrupy, substantially gel-free, pourable viscous liquid of unpolymerized monomer and polymer. Prepolymerization of polyol (allyl carbonate)-functional monomer compositions have been described by PPG Industries (U.S. Pat. No. 4,613,656, U.S. Pat. No. 4,686,266, U.S. Pat. No. 4,959,429, U.S. Pat. No. 4,959,433, U.S. Pat. No. 5,017,666 and U.S. Pat. No. 6,057,411, each of which is incorporated herein by reference). Additional methods for generating polymers of the invention are described in U.S. Pat. Nos. 4,346,197, 4,396,737, 4,398,008, 4,590,248 and 4,622,376, each of which is incorporated herein by reference. If desired, the electrokinetic device can be generated by polymerizing a prepolymer of polyol (allyl carbonate). Polyol (allyl carbonate)-functional monomer compositions can therefore be readily molded into shapes convenient for electrokinetic devices particularly capillary electrophoresis and capillary electrochromatography devices.

Diol bis(allyl carbonate) monomers are normally linearly polymerized aliphatic liquid allyl carbonates, that is, glycol bis(allyl carbonate) compounds, in which the allyl groups can be substituted at the 2 position with a halogen, notably chlorine or bromine, or a 1 to 4 carbon alkyl group, generally a methyl or ethyl group, and the glycol group can be an alkylene, alkylene ether, alkylene polyether or alkylene carbonate group having from 2 to 10 carbons and oxygens. These diol bis(allyl carbonate) monomers are represented by the formula:

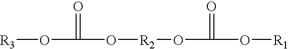

where R₁ and R₃ are allyl or substituted allyl groups, and R₂ is as defined below. R₁ and R₃ are independently represented by the formula:

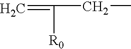

where R₀ can be hydrogen, halogen, or a 1 to 4 carbon alkyl group. Specific examples of R₁ and R₃ include allyl, 2-chloroallyl, 2-bromoallyl, 2-iodoallyl, 2-fluoroallyl, 2-methallyl, 2-ethylallyl, 2-isopropylallyl, 2-n-propylallyl, and 2-n-butylallyl groups. Most commonly, R₁ and R₃ are allyl groups, H₂C═CH—CH₂—. Such compounds and methods for making them are disclosed in U.S. Pat. Nos. 2,370,567 and 2,403,113, each of which is incorporated herein by reference.

Specific examples of R₂ include alkylene groups containing from 2 to 10 carbons such as ethylene, trimethylene, methylethylene, tetramethylene, ethylethylene, pentamethylene, hexamethylene, 2-methylhexamethylene, octamethylene, and decamethylene groups, alkylene ether groups such as —CH₂OCH₂—, —CH₂CH₂OCH₂CH₂—, —CH₂OCH₂CH₂—, and —CH₂CH₂CH₂OCH₂CH₂CH₂—, alkylene polyether groups such as —CH₂CH₂OCH₂CH₂OCH₂CH₂OCH₂CH₂OCH₂CH₂—, and CH₂OCH₂— groups, and alkylene carbonate and alkylene polycarbonate groups such as CH₂CH₂O(C═O)OCH₂CH₂ and —CH₂CH₂OCH₂CH₂O(C═O)OCH₂CH₂OCH₂CH₂— groups. Most commonly, R₂ is —CH₂CH₂—, —CH₂CH₂OCH₂CH₂—, or —CH₂CH₂OCH₂CH₂OCH₂CH₂.

Specific examples of polyol (allyl carbonate) monomers useful in carrying out the method herein contemplated include ethylene glycol bis(2-chloroallyl carbonate), diethylene glycol bis(2-methallyl carbonate), triethylene glycol bis(allyl carbonate), propylene glycol bis(2-ethylallyl carbonate), 1,3-propanediol bis(allyl carbonate), 1,3-butanediol bis (allyl carbonate), 1,4-butanediol bis(2-bromoallyl carbonate), dipropylene glycol bis(allyl carbonate), trimethylene glycol bis(2-ethylallyl carbonate), pentamethylene glycol bis(allyl carbonate), isopropylidene bisphenol bis(allyl carbonate), oxy bisphenol bis(allyl carbonate), sulfonyl bisphenol bis(allyl carbonate), and the tris(allyl carbonate) of tris(2-hydroxyethyl)isocyanurate.

Commercially important polyol (allyl carbonate) monomers that can be polymerized for the invention herein contemplated are:

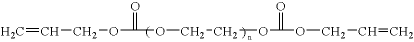

where n=1 to 3. A particularly useful polyol (allyl carbonate) is diethylene glycol bis(allyl carbonate). This monomer is commercially available from PPG Industries, Inc. and is sold under the trademark CR-39 Allyl Diglycol Carbonate™ (PPG Industries; Gurnee Ill.).

In addition to the above-described references, methods describing the use of triol (allyl carbonates) and other polymeric forms described below can be found, for example, in U.S. Pat. Nos. 2,370,565, 2,370,567, 2,385,933, 2,403,113, 2,407,446, 2,464,056, 2,587,437, 3,385,836, 3,751,374, 4,083,819, 4,139,578, 4,311,762, and 4,346,197, each of which is incorporated herein by reference.

Triol tris(allyl carbonates) that can be polymerized and are useful in the invention are represented by the formula:

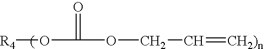

where R₄ is an organic moiety chosen from the group consisting of moieties derived from polyols and extended polyols, most frequently a triol or extended triol where the hydroxyl groups of the precursor polyol R₄(OH)ₙ are non-vicinal. Such triol tris(allyl carbonates) can be either homopolymerized or copolymerized, for example, with polyol (allyl carbonates) such as diol bis(allyl carbonates).

By non-vicinal it is meant that the hydroxyl groups are not on adjacent carbons. Specific triol precursors useful in preparing the tris(allyl carbonate) materials useful in this invention are triols with primary or secondary hydroxyl groups. Triols having primary hydroxyl groups are particularly useful precursors. One such class of triols is 1,1,1-trimethylol alkanes. Also useful are extended trimethylol alkyl tris(allyl carbonate) monomers such as lactone extended trimethylol alkanes and alkyl oxide extended trimethylol alkanes. By an extended triol is meant the reaction product having terminal hydroxyl groups of the triol and a suitable reactant, for example, an alkyl oxide or a lactone. Typical lactone extended trimethylol alkanes include epsilon~caprolactone extended trimethylol methane, epsilon~caprolactone extended trimethylol ethane, epsilon~caprolactone extended trimethylol propane, and epsilon~caprolactone extended trimethylol butane. Typical alkyl oxide extended triols include ethylene oxide extended trimethylol methane, ethylene oxide extended trimethylol ethane, ethylene oxide extended trimethylol propane, ethylene oxide extended trimethylol butane, propylene oxide extended trimethylol methane, propylene oxide extended trimethylol methane, propylene oxide extended trimethylol ethane, and propylene oxide extended trimethylol butane.

Particularly useful polyols meeting these requirements have the general formula R₅(OH)ₙ, where n is greater than 2, up to about 8 and generally is about 3. R₅ can be:

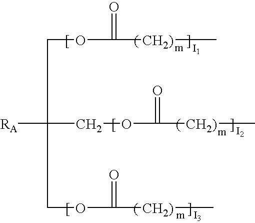

where R_{A} is H, —CH₃, —CH₂CH₃, —CH₂CH₂CH₃, or —CH₂CH₂CH₃, and I₁, I₂ and I₃ are each integers from 0 to 5 and the sum of I₁+I₂+I₃ is 2 or more and generally from 2 to 8, although values as high as 15 are possible. The value of m depends on the lactone utilized to extend the polyol and is generally 4 or 5.

The chain extending lactone can be a delta lactone having the formula:

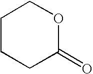

which can be substituted with hydrogen, methyl groups, or ethyl groups.

According to a still further exemplification, the chain extending lactone group can be an epsilon lactone having the formula:

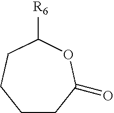

where R₆ is hydrogen, a methyl group, or an ethyl group and where R₅ can be on any of the carbons other than the carbonyl carbon. One exemplary triol is Union Carbide Corporation NIAX PCP-0301 brand epsilon-caprolactone extended trimethylol propane (Union Carbide/DOW Chemical Co.; Midland Mich.).

According to a still further exemplification, R₅ can be:

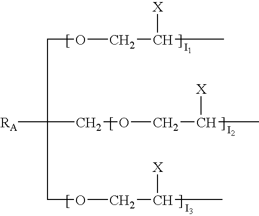

where R_{A} is as defined above, I₁, I₂, and I₃ are integers from 0 to 5 and the sum of I₁+I₂+I₃ is 2 or more and generally from about 2 to 8, although values as high as about 15 are possible, and X is H or CH₃. The chain extenders can be ethylene oxide groups as exemplified by Upjohn ISONOL 93 ethylene oxide extended trimethylol propane (Pharmacia & Upjohn; Peapack N.J.). Alternatively, the extenders can be propylene oxide groups as in BASF-Wyandotte PLURACOL TP brand propoxylated trimethylol propane (BASF; Mount Olive N.J.).

According to a still further exemplification, R₅(OH)₃ can be an extended glycerol, for example, ethylene oxide extended glycerol having the general formula:

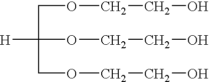

or propylene oxide extended glycerol having the formula:

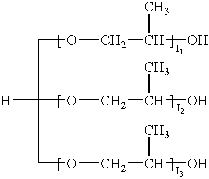

or a lactone extended glycerol having the formula:

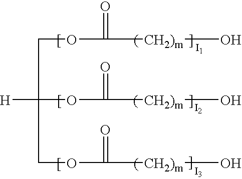

where m and I₁, I₂, and I₃ are as defined above. Typical propoxylated glycerines include DOW VORANOL 2025 brand propoxylated glycerine having a molecular weight of about 260 grams per gram mole (DOW Chemical Co.), DOW VORANOL 2070 brand propoxylated glycerine having a molecular weight of about 700 grams per gram mole (DOW Chemical Co.), and BASF-Wyandotte PLURACOL GP730 brand propoxylated glycerine having a molecular weight of about 730 grams per gram mole (BASF).

Other monomeric or polymeric materials can be introduced into the monomeric polyol (allyl carbonate) and polymerized therewith. These materials can be added to alter viscosity of the polyol (allyl carbonate) while monomeric, thereby making processing easier. For example, olefinically unsaturated monomers, such as ethylene, propylene, isobutylene, methylpentene, butadiene, isoprene, vinyl acetate, acrylic acid, methacrylic acid, methyl acrylate, ethyl acrylate, methyl methacrylate, ethyl methacrylate, acrylonitrile, acrylamide, vinyl chloride, vinylidene chloride, vinyl pyrrolidene, vinyl pyridene, vinyl-methyl ether, vinyl ethyl ether styrene, divinyl benzene, and mixtures thereof can be introduced into the monomeric polyol (allyl carbonate) and co-polymerized. Alternatively, allyl monomers, such as allyl alcohol, can be introduced into the monomeric polyol (allyl carbonate), or even monomers having allyl and vinyl functionality, such as allyl methacrylate or allyl acrylate, can be introduced into the polyol (allyl carbonate).

Alternatively a polymeric material can be introduced into the polyol (allyl carbonate) monomer. Exemplary polymers that can be co-polymerized with a polyol (allyl carbonate) polymer are described below.

As herein contemplated, the polymer can be a monofunctional homopolymer or a copolymer of monofunctional monomers, or a copolymer of a monofunctional monomer and a difunctional monomer. When the polymer is a polymer of a difunctional monomer, or a copolymer of a monofunctional monomer and a difunctional monomer, the difunctional monomer can have functional groups of high and low reactivity, for example, a vinyl group and an allyl group, and the monofunctional monomer can be a vinyl monomer.

A particularly useful copolymer is a copolymer of (a) an acrylate, that is, an acrylate ester or an acrylic acid, and (b) an ester of an acrylic acid and an allyl alcohol or substituted allyl alcohol. The difunctional monomer can be allyl acrylate, allyl methacrylate, or the like, and the monofunctional monomer can be methyl acrylate, methyl methacrylate, ethyl acrylate, ethyl methacrylate, or the like. In this way there is provided a linear, minimally cross linked, soluble, swellable polymer, with polymerization predominantly through the vinyl groups.

Alternatively, the polymer can be a polymer of a monomer having mono-olefinic unsaturation, for example, poly(styrene), poly(acrylonitrile), poly(vinyl chloride), poly(vinylidene chloride), poly(vinyl fluoride), poly(vinylidene fluoride), poly(vinyl acetate), poly(acrylic acid), poly(methacrylic acid), poly(methyl acrylate), poly(ethyl acrylate), poly(butyl acrylate), poly(methyl methacrylate), poly(ethyl methacrylate), poly(butyl methacrylate), poly(acrylamide), poly(ethylene), poly(propylene), poly(allyl acrylate), poly(allyl methacrylate), and copolymers thereof. Alternatively, the polymer can be a heterochain polymer, that is, a condensation polymer. Suitable heterochain polymers include saturated polyesters such as terephthalates, for example, polyethylene terephthlate, and polycarbonates; polyethers, such as polyacetal, poly(ethylene oxide), poly(propylene oxide), poly(epichlorohydrin), poly(epichlorohydrin-ethylene oxide), poly(tetrahydrofuran); or polyamides and polyimides.

Particularly useful polymers are homopolymers of diethylene glycol bis(allyl carbonate) or copolymers containing about 10% or more of diethylene glycol bis (allyl carbonate). In addition, a copolymer can contain about 15% or more of diethylene glycol bis(allyl carbonate), about 20% or more of diethylene glycol bis(allyl carbonate), about 25% or more of diethylene glycol bis(allyl carbonate), about 30% or more of diethylene glycol bis(allyl carbonate), about 35% or more of diethylene glycol bis(allyl carbonate), about 40% or more of diethylene glycol bis(allyl carbonate), about 45% or more of diethylene glycol bis(allyl carbonate), about 50% or more of diethylene glycol bis(allyl carbonate), about 60% or more of diethylene glycol bis(allyl carbonate), about 70% or more of diethylene glycol bis(allyl carbonate), about 80% or more of diethylene glycol bis(allyl carbonate), about 90% or more of diethylene glycol bis(allyl carbonate), or about 95% or more of diethylene glycol bis(allyl carbonate). Similarly, other polyol (allyl carbonate) polymers can be synthesized as co-polymers of variable percentages, as described above, for example, about 10%, about 15%, about 20%, about 25%, about 30%, about 35%, about 40%, about 45%, about 50%, about 60%, about 70%, about 80%, about 90% or about 90% polyol (allyl carbonate).

In addition to the above-described copolymers, an electrokinetic device of the invention can also be made by applying a polyol (allyl carbonate) coating to an electrokinetic device. Accordingly, the invention provides an electrokinetic device comprising a polyol (allyl carbonate) polymer, where the polymer is coated onto an electrokinetic device. For example, the polyol (allyl carbonate) polymer can be coated onto a glass, silicon, polystyrene, polypropylene, or any desired material useful in methods of the invention.

Additionally, colorants can be present in the monomer, whereby to provide a colorant in the casting.

The polymerization of the polyol (ally carbonate) composition is initiated by the creation of active centers, for example, free radicals. Useful free radical initiators are peroxy initiators. The peroxy initiators include: isobutyryl peroxide; di(2-ethylhexyl) peroxydicarbonate; acetyl cyclohexane sulfonyl peroxide; di(sec-butyl) peroxydicarbonate; diisopropyl peroxydicarbonate; 2,4-dichlorobenzoyl peroxide, t-butyl peroxypivalate; decanoyl peroxide; lauroyl peroxide, propionyl peroxide; 2,5-dimethyl-2,5-bis(2-ethyl hexylperoxy)hexane; acetyl peroxide; succinic acid peroxide; t-butyl peroxyoctoate; benzoyl peroxide; p-chlorobenzoyl peroxide; t-butyl peroxyisobutyrate; t-butyl peroxymaleic acid; bis(1-hydroxycyclohexyl) peroxide, 1-hydroxy-1′-hydroperoxy dicyclohexyl peroxide; t-butyl peroxyisopropyl carbonate; 2,5-dimethyl-2,5-bis(benzoylperoxy)hexane; t-butyl peroxyacetate; methyl ethyl ketone peroxides; di-t-butyl diperoxyphthalate and t-butyl peroxybenzoate. Methods for initiating polymerization with free radicals are well known to those skilled in the art (Borton, Complexes in Free-radical Polymerization, Elsevier, N.Y. (1988); Bamford and Tipper, eds., Free-radical Polymerization, Elsevier, N.Y. (1976); Bevington, Radical Polymerization, Academic Press, New York (1961)).

Particularly useful peroxy initiators are those that do not discolor, char, or burn the resulting polymerizate. Exemplary initiators are diisopropyl peroxydicarbonate and benzoyl peroxide.

The invention provides an electrokinetic device comprising one or more ligands immobilized to a polyol (allyl carbonate) polymer support. The invention also provides a polyol (allyl carbonate) electrokinetic device modified for attachment of a chemical moiety.

The electrokinetic device of the invention can be used for a variety of purposes where an electrokinetic device having clarity, low fluorescence, solvent resistance and the ability to be chemically modified to allow attachment of a chemical moiety is desired. For example, the electrokinetic device can be used for analysis of organic compounds, for the analysis of biochemicals, for the analysis of ions, for the analysis of metals, for the analysis of proteins, for the analysis of oligonucleotides, for the analysis of oligosaccharides, for the analysis of pollutants, for the analysis of pesticides, for the analysis of chemical threat agents, for the analysis of explosives, for the analysis of drugs, for the analysis of biological threat agents, and the like.

Methods for synthesizing chemical compounds on solid phase are well known to those skilled in the art (see, for example, Mendonca and Xiao, Med. Res. Rev. 19:451-462 (1999); van Maarseveen, Comb. Chem. High Throughput Screen. 1:185-214 (1998); Andres et al., Comb. Chem. High Throughput Screen. 2:191-210 (1999); Sucholeiki, Mol. Divers. 4:25-30 (1998-1999); Ito and Manabe, Curr. Opin. Chem. Biol. 2:701-708 (1998); Labadie, Curr. Opin. Chem. Biol. 2:346-352 (1998); Backes and Ellman, Curr. Opin. Chem. Biol. 1:86-93 (1997); Kihlberg et al., Methods Enzymol. 289:221-245 (1997); Blackburn and Kates, Methods Enzymol. 289:175-198 (1997); Meldal, Methods Enzymol. 289:83-104 (1997); Merrifield, Methods Enzymol. 289:3-13 (1997); Thuong and Asseline, Biochimie. 67:673-684 (1985); Wang et al., Science 279:1712-1714 (1998)). These and related methods may be used to attach molecules such as ligands or small organic molecules to the surface of the polyol (allyl carbonate) in order to confer a particular characteristic such as an EOF of a given strength when used in conjunction with a specified buffer.

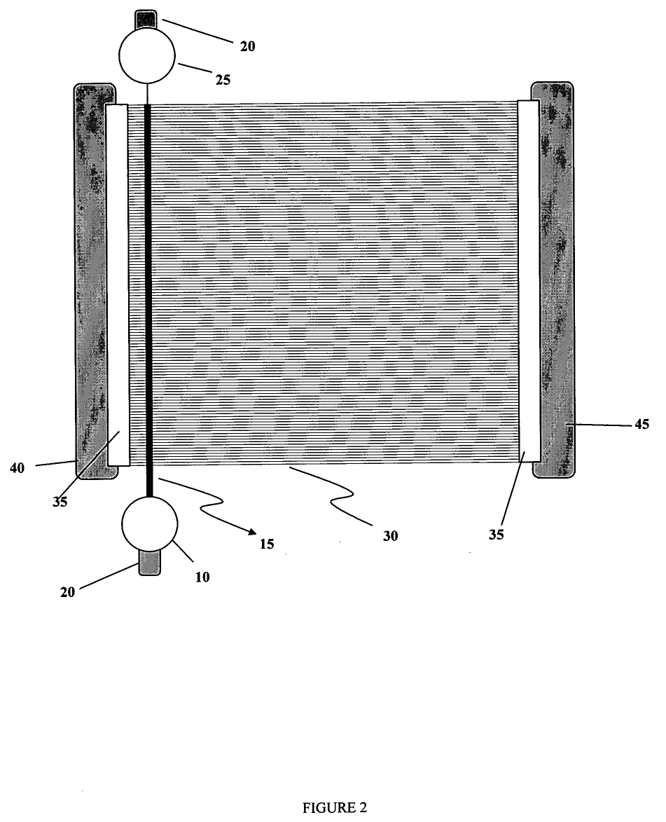

The invention also provides a polyol (allyl carbonate) electrokinetic device for the 2-D separation of complex mixtures (FIG. 2). This device is composed of a primary microchannel wherein a mixture of molecules is separated based upon ionic interactions, hydrophobic interactions, isoelectric separation, or any chromatographic or electrokinetic principle. Intersecting this first channel are multiple secondary channels wherein molecules are separated based upon properties other than those primarily employed in the first dimension separation. An exemplary use of this 2-D device includes the analysis of protein mixtures.

Referring to FIG. 2, a 2-D device of the invention is shown and may be used for the separation of large mixtures of proteins. All microchannels, 15 and 30, and reservoirs, 10, 25, and 35, are filled with buffer. The sample to be analyzed is placed in well 10. An electrical potential is placed across electrodes 20. Proteins move into the first microchannel, 15, and undergo separation based upon their isoelectric points, ionization, hydrophobicity, partition between a buffer additive such as a detergent or cyclodextran and the buffer, partition between microchannel packing materials and the buffer, or partition between the microchannel wall and the buffer. At some predetermined time, the potential between electrodes 20 is stopped and a potential is applied across electrodes 40 and 45. Proteins migrate into one of the secondary microchannels, 30, in closest proximity to their position in microchannel 15 and are separated based upon an electrophoretic or chromatographic principle different from that used in the primary microchannel. Proteins are detected by detectors oriented at the ends of each of the secondary microchannels, by imaging, by collection of fractions as they are emitted from the secondary microchannels, by direct injection into a mass spectrometer, or by other detection methods known to those skilled in the art.

The invention also provides a method for attaching a chemical compound to an electrokinetic device. The method includes the step of contacting a polyol (allyl carbonate) electrokinetic device modified for attachment of a chemical moiety with a first chemical moiety. The method can further include the step of contacting the electrokinetic device with a second chemical moiety. The method can even further include optionally repeating the addition of one or more chemical moieties to the electrokinetic device. It is understood that any desired chemical can be used in any desired order. For example, the second chemical moiety can be the same or different than the first chemical moiety. Similarly, any additional chemical moiety can be a new chemical moiety, or can be the same as a previously added chemical moiety.

The ligands can be attached to the electrokinetic device through either covalent or noncovalent interactions. For example, a nucleic acid ligand can be bound via noncovalent interactions to a polyol (allyl carbonate) electrokinetic device modified to contain a positively charged group such as an amine. Thus, the invention provides a polyol (allyl carbonate) electrokinetic device modified for attachment of a molecule via noncovalent interactions, for example, modified to contain a hydrophobic functional group suitable for hydrophobic interactions or a positively or negatively charged functional group suitable for ionic interactions. Such groups on the electrokinetic device can also function as reactive groups for covalent coupling to a chemical moiety or ligand if the chemical moiety or ligand is reactive with the functional group. Ligands attached to the electrokinetic device may be used to alter surface chemical properties such as hydrophobicity, ionization, the zeta potential, or other parameters useful for optimization of separation protocols.

A variety of methods can be used to modify the electrokinetic device for attachment of a chemical moiety. For example, as disclosed herein, hydroxide such as potassium hydroxide, sodium hydroxide and the like can be used to derivatize a polyol (allyl carbonate) electrokinetic device for attachment of a chemical moiety (see Example III). Other methods for modifying an electrokinetic device for attachment of a chemical moiety or ligand can be readily determined by those skilled in the art. Other methods suitable for modifying a polyol (allyl carbonate) include, but are not limited to, plasma phase modification and copolymerization of the polyol (allyl carbonate) with a reagent containing a reactive functionality. For example, inclusion of an allylic amine during polymerization can be used to generate an aminated polymer useful for binding a chemical moiety or ligand, such as a polypeptide or nucleic acid, or a cell. Similarly, other polyol (allyl carbonates) having desirable chemical properties can be used to generate a polymer suitable for a particular use.

For plasma phase modification, plasma is generated by processing gas into an excited state by application of radio waves under reduced pressure. The excited gas is characterized by high energy radicals and ions. Exposure of the plastic to the excited gas causes deposition of the gas molecules onto the surface of the plastic. For example, deposition of amines can be carried out in an atmosphere of ammonia gas. Plasma phase modification of plastics can be effected with commercially available equipment like that manufactured by Europlasma (Belgium).

In addition to modifying a polyol (allyl carbonate) polymer (as disclosed herein in Example III), a polyol (allyl carbonate) polymer can be copolymerized in the presence of a reagent that provides a functional group suitable for binding to a chemical moiety or ligand. For example, a polyol (allyl carbonate) polymer can be copolymerized with a reagent containing a reactive functionality such as an amine or carboxylic acid, which can function both for noncovalent interactions and covalent interactions with a chemically reactive moiety.

The invention additionally provides a method for generating a polyol (allyl carbonate) electrokinetic device by polymerizing a prepolymer of polyol (allyl carbonate), thereby generating a polyol (allyl carbonate) electrokinetic device. As described above, the use of a prepolymer can be advantageously used to minimize shrinkage during polymerization of a polyol (allyl carbonate). Use of a prepolymer can be useful in obtaining desirable characteristics of the polyol (allyl carbonate) electrokinetic device.

The invention also provides a microfluidic device comprising a polyol (allyl carbonate) polymer that can be used with aqueous or organic fluids. The devices can be machined or molded to include microchannels and wells and can optionally incorporate electrical connections. The surface of the microchannels and wells can be chemically modified to allow the attachment of chemical moieties or for modification of surface chemical properties including, but not limited to, hydrophobicity, ionic charge, and electroosmotic potential. Such modifications can similarly be included in any of the electrokinetic devices of the invention. The surface of the microchannels and wells can be chemically modified to alter the interaction of chemical moieties with the polyol (allyl carbonate) polymer as with the migration of chemical moieties in an electric field along the length of a microchannel.

Microfluidic devices and electrokinetic devices their applications, and standard manufacturing methods used for microfluidic devices have been described previously (Becker and Gartner, Electrophoresis 21:12-26 (2000); Freemantle, Chem. Eng. News 77:27-36 (1999); Voldman et al., Ann. Rev. Bioengineer 1:401-425 (1999); Chovan and Guttman, Trends Biotechnol. 20:116-122 (2002); DeWitt, Curr. Opin. Chem. Biol. 3:350-356 (1999); Krishnan et al., Curr. Opin. Biotechnol. 12:92-98 (2001); Manz, ed., Microsystem Technology in Chemistry and Life Sciences, Springer-Verlag, N.Y. (1999); Koch et al., Microfluidic Technology and Applications, Research Studies Press Limited, Tauton, Somerset, England (1999), and references cited therein). One skilled in the art can readily determine various applications of a polyol (allyl carbonate) polymer as a microfluidic device.

As used herein, the term “microchannel” refers to a channel less than 1 mm in width and 1 mm in depth. Microchannels can range in width or depth of 1 mm or less, 500 μm or less, 200 μm or less, 100 μm or less, 50 μm or less, 20 μm or less, 10 μm or less, 5 μm or less, 1 μm or less, or even smaller dimensions. Microchannels can have planar or curved walls and can be formed by molding, casting, micromachining, ablation, lithography, or any other method known to those skilled in the art.

As used herein, the term “microfluidic device” is intended to refer to devices with one or more microchannels used for the transfer or storage of a fluid. Microfluidic devices can optionally be used in conjunction with pumps, valves, electric currents, wells, mixers, or analytical detection systems.

Thus, the invention also provides a microfluidic device comprising a polyol (allyl carbonate) polymer electrokinetic device having one or more microchannels and one or more wells. The microfluidic device can be any desired composition of polyol (allyl carbonate), as disclosed herein, for example, diethylene glycol bis(allyl carbonate) of various percent composition. The microchannels can be formed by laser ablation (see Example VI). The microchannels can also be formed by molding or casting.

If desired, the microfluidic device can contain one or more ligands immobilized in the microchannels, as described above.

The microfluidic device can be modified to contain chemical functional groups with desirable chemical properties such as reactive groups, ionic, polar, hydrophobic, aromatic, or any desirable chemical property. For example, the chemical functional group can comprise an amine group, an alkyl group, a hydroxyl group, an aromatic group, a carboxylate group, or any desired chemical functionality.

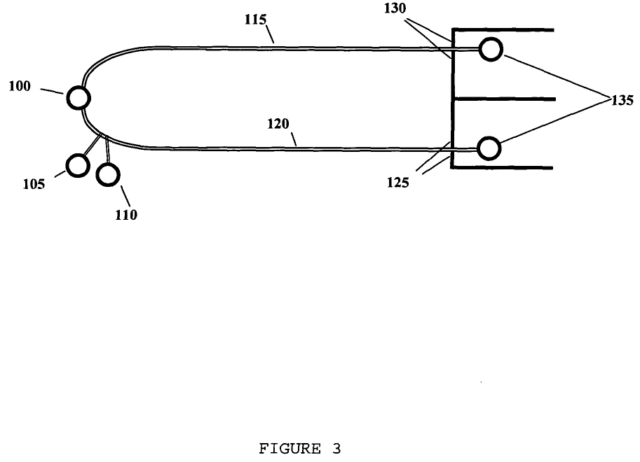

The invention also provides for a detector incorporated in a microfluidic or electrokinetic device based upon electrical resistance or impedance. This detector would include two pairs of electrodes; one pair of electrodes oriented such that a microchannel passes between at least a portion of a gap between the electrodes. A second pair of electrodes is oriented such that a reference microchannel passes between at least a portion of a gap between the electrodes. The electrodes are interconnected so that the two gaps represent to resistive elements on a Wheatstone bridge or other null-point detection system (FIG. 3). In this fashion, direct resistance or impedance measurements are not measured, rather resistance or impedance in a microchannel relative to a reference microchannel. Polarization of the electrodes may be minimized by using pulsed wave DC current or modulated DC current such as a square wave or sinusoidal wave or by using AC current. The frequency of current may be adjusted in order to increase sensitivity for the analyte of interest.

Referring to FIG. 3, the detector of said invention may be used in an electrophoresis or electrochromatography device where buffer would be placed in all reservoirs (100, 105, 110, and 135) and microchannels (115 and 120). Sample is placed in sample reservoir 105 and separated in microchannel 120. Modulations in electrical signals as sample passes between sample electrodes 125 and electrically compared to the electrical signal generated between the reference electrodes 130.

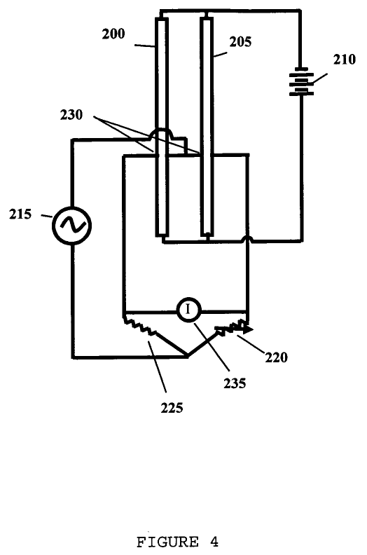

The said detector of the invention is furthermore a null point detection system as shown in FIG. 4. A DC current is used to separate analytes in a separation capillary 200 and compared to a reference microchannel 205 through which an equivalent DC current is passed. An alternating current 215 is passed through electrodes 230 which form two resistive elements of a Wheatstone bridge configuration along with a resistor 225 and a variable resistor 220. The variable resistor 220 may be used to zero the detector by balancing the current between the reference path and the sample path such that there is a null current detected at a sensitive amp meter or other electrical detection device 235. As analyte molecules move between electrodes 230 in the sample path the conductivity, resistance, capacitance, and or the impedance changes relative to the electrical properties between the electrodes 230 in the reference microchannel. This difference in electrical properties results in a change in current as detected at 235.

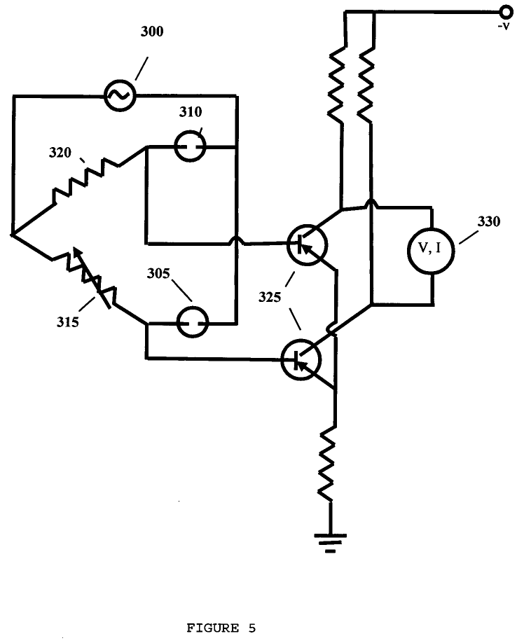

The sensitivity of the null point detector of the present invention may be further amplified by integration with a differential amplifier as shown in FIG. 5. An AC current applied to the detector circuit where the gap between the sample electrodes 305 and the reference electrode 310 compose two legs of a Wheatstone bridge along with a variable resistor 315. Current generated by differences between the resistance, capacitance, or impedance at electrodes 305 and 310 are used as inputs to two matched transistors 325 coupled through their emitters. If the inputs are equivalent, then the output signal 330 will be zero. Otherwise, a response to signal differences is observed.

AC Electrokinetic techniques such as dielectrophoresis (Jones, T B (1995) Electromechanics of particles. Cambridge: Cambridge University Press) and electrorotation (Zimmermann U, Neil G A (1996) Electromanipulation of cells. CRC press) have been utilized for many years for the manipulation, separation and analysis of cellular-scale particles. The phenomenon occurs due to the interaction of induced dipoles with electric fields, and can be used to exhibit a variety of motions including attraction, repulsion and rotation by changing the nature of the dynamic field. The alternative, and more popular, means of transporting particles using AC electrokinetics is by the application of traveling-wave dielectrophoresis. Whilst the majority of work on traveling-wave dielectrophoresis has concerned micrometer-sized objects such as blood cells [Morgan H, Green N G, Hughes M P, Monaghan W, Tan T C (1997) “Large-area travelling-wave dielectrophoresis particle separator” J. Micromech. Microeng., 7 65-70), some work has been performed on the concentration of particles on a surface using so-called “meander” electrodes Fuhr G, Fiedler S, Müller T, Schnelle T, Glasser H, Lisec T, Wagner B (1994) “Particle micromanipulator consisting of two orthogonal channels with traveling-wave electrode structures” Sensors and Actuators A, 41/42 230-239). These structures use four electrodes in a series of interlocking spirals to generate a traveling wave; at the center of the spiral, the electrodes form a quadrupole-type electrode array. It has been demonstrated that by careful manipulation of the amplitudes of the potentials on these electrode structures, it is possible to “steer” the motion of particles across the array. It is therefore feasible to make use of the dielectrophoretic motion of cells and virus particles within an AC current in order to sort and identify specific species. The ability to chemically modify the surface properties of polyol (allyl carbonate) polymers allows for the construction of devices that combine microfluidic, electrophoretic, and dielectrophoretic principles in order to sort, identify and quantify specific cells or virus particles such as biological threat agents.

It is understood that modifications that do not substantially affect the activity of the various embodiments of this invention are also provided within the definition of the invention provided herein. Accordingly, the following examples are intended to illustrate but not limit the present invention.

### EXAMPLE I

### Stability of Diethylene Glycol Bis(allyl carbonate) Polymer in Solvents

This example describes the stability of diethylene glycol bis(allyl carbonate) polymer in various solvents.

Pre-weighed 2 cm×2 cm chips of diethylene glycol bis(allyl carbonate) polymer were submerged in various solvents or reagents commonly used in solid phase oligonucleotide and peptide synthesis for 3 hours at room temperature. The solvents used were dimethylformamide (DMF), dichloromethane (DCM), methanol, acetonitrile, acetone, 20% piperidine in DMF, 1% trifluoroacetic acid (TFA) in DCM, and water. A chip unexposed to any solvent was used as a control. The chips were removed from the solution and wiped dry. The change in weight and % transmittance of light at various wavelengths was then determined for each chip. The results observed at 400 nm are shown in Table 1.

TABLE 1
Effect of Solvents on Diethylene Glycol
Bis(allyl carbonate) Polymer

| Condition | % weight | % T (400 nm) |
|---|---|---|
| Control | <0.3 | <3 |
| (S.D. 3) | | |
| DMF | <0.3 | 3.6 |
| DCM | 3.4 | 6.5 |
| Methanol | <0.3 | 6.1 |
| Acetonitrile | 0.5 | 3.5 |
| Acetone | <0.3 | <3 |
| 20% piperidine/DMF | <0.3 | <3 |
| 1% TFA/DCM | 3.0 | 6.0 |
| water | <0.3 | <3 |

As shown in Table 1, there was no significant change in weight or percent transmittance at 400 nm. Similarly, there was no significant change in percent transmittance at 280, 300, 320, 340, 360, 380 or 600 nm.

These results show that the polyol (allyl carbonate) polymer diethylene glycol bis(allyl carbonate) is resistant to a variety of solvents and maintains clarity after exposure to a variety of solvents.

### EXAMPLE II

### Intrensic Fluorescence of Diethylene Glycol Bis(allyl carbonate) Polymer

This example describes the intrinsic fluorescence properties of diethylene glycol bis(allyl carbonate) polymer.

The emission spectrum of a 12.5 cm×8.5 cm×0.2 cm sheet of diethylene glycol bis(allyl carbonate) polymer was measured in a Molecular Devices SPECTRAmax Gemini XS spectrofluorometer (Molecular Devices; Sunnyvale Calif.) over the wavelength range of 300 nm to 600 nm with an excitation wavelength of 260 nm. This spectrum was compared to the spectrum generated from an inverted Corning-CoStar polystyrene plate (Corning; Acton Mass.). Polystyrene showed emission peaks at 330 nm and 510 nm. Diethylene glycol bis(allyl carbonate) polymer showed no detectable fluorescence in the range of 300 nm to 600 nm.

These results show that the polyol (allyl carbonate) polymer diethylene glycol bis(allyl carbonate) exibits low intrinsic fluorescence.

### EXAMPLE III

### Dervitization of Diethylene Glycol Bis(allyl carbonate) Polymer

This example describes the derivatization of diethylene glycol bis(allyl carbonate) polymer at discrete locations.

The surface of a 12.5 cm×8.5 cm×0.2 cm sheet of polymerized diethylene glycol bis(allyl carbonate) was covered with cellophane tape having 96 holes of 0.8 cm diameter distributed in an 8×12 array. This sheet was floated, tape side down, in a bath of 45% (w/v) aqueous potassium hydroxide for three hours at room temperature. The sheet was washed extensively with water and the tape was removed. Hydrolysis of carbonate bonds in the polymer was demonstrated by the formation of water beads on the surface of the sheet in locations corresponding to the 8×12 array.

These results show that the polyol (allyl carbonate) polymer diethylene glycol bis(allyl carbonate) can be derivatized at discrete locations. Such derivatized locations are suitable for attachment of chemical moieties on an electrokinetic device.

### EXAMPLE IV

### Coupling of Amino Acid to Diethylene Glycol Bis(allyl carbonate) Polymer

This example describes attachment of a chemical moiety to derivatized diethylene glycol bis(allyl carbonate) polymer.

1 mmol FMOC Ser(trt)-OH was dissolved in a minimum volume of dry DMF. To this solution, 1 mmol dicyclohexylcarbodiimide (DCC) in dry DCM was added to the amino acid solution and incubated at 0° C. for 30 min. Hydroxide treated diethylene glycol bis(allyl carbonate) polymer was submerged in a minimum amount of dry DMF, and the amino acid solution was added. 0.1 mmol dimethylaminopyridine (DMAP) was added with 0.1 g molecular sieves. The reaction was covered and allowed to stand 1 hr at room temperature with occasional swirling. The derivatized polymer was washed with an excess DMF.

Alternatively, 1 mmol FMOC-Ser(trt)-OH was dissolved in a minimum volume of dry DMF. To this solution, 1 mmol DCC in dry DCM was added to the amino acid solution and incubated at 0° C. for 30 min. Hydroxide treated diethylene glycol bis(allyl carbonate) polymer was activated in 20 mL dry tetrahydrofuran (THF) containing 0.25 mmol diimidazole carbonyl, 75 mmol dimethylaminopyridine (DMAP) and about 0.1 g molecular sieves for 3 hours at room temperature. The activated slide was washed with dry THF and dry DMF and was submerged in a minimum amount of dry DMF, to which the amino acid solution was added. 0.1 mmol DMAP was added with 0.1 g molecular sieves. The reaction was covered and allowed to stand 1 hr at room temperature with occasional swirling. The derivatized polymer was washed with an excess DMF.

Coupling was verified by removal of fluorenylmethyloxycarbonyl (FMOC) with 20% piperidine in DMF and detection of the primary amine using the Kaiser test. The Kaiser test was carried out by preparation of three solutions. Solution 1 consists of 5 g ninhydrin in 100 ml ethanol. Solution 2 consists of 80 g liquified phenol in 20 ml ethanol. Solution 3 is a mixture of 2 ml of 1 mM aqueous sodium cyanide in 98 ml pyridine. The active reagent was formed by mixing equal volumes of each of solutions 1 to 3 and adding the resulting mixture dropwise to the test sample. The sample exposed to the active reagent was dried at 110° C. for 10 minutes. The presence of a primary amine was confirmed by the appearance of a blue coloring after 5 minutes at 120° C.

These results show that a chemical moiety can be attached to derivatized diethylene glycol bis(allyl carbonate).

### EXAMPLE V

### Bromination of Diethylene Glycol Bis(allyl carbonate) Polymer

This example describes the attachment of a chemical moiety to a derivatized diethylene glycol bis(allyl carbonate) polymer.

Hydroxide treated diethylene glycol bis(allyl carbonate) polymer is submerged in a solution of 200 mM carbon tetrabromide in DCM for 15 hours at room temperature with 100 mM triphenylphosphine. The brominated polymer is washed extensively with DMF. The coupling of the amine is carried out by addition of 1 mmol FMOC-propylene diamine added in a minimum amount of DCM and allowed to stand covered for 3 hours at room temperature. Coupling is verified following removal of FMOC with 20% piperidine in DMF using the Kaiser test.

### EXAMPLE VI

### Laser Ablation of Diethylene Glycol Bis(allyl carbonate) Polymer

This example describes the machining of microchannels in diethylene glycol bis(allyl carbonate) polymer.

Microchannels 20 μm wide were laser ablated into diethylene glycol bis(allyl carbonate) polymer slides (1″×3″×1/16″) using an Electro Scientific, Inc. (Portland, Oreg.) 4440 Laser Micromachining System. This system used a solid state pulsed diode laser adjusted to emit light at 266 nm. Pulsewidths of 15-20 ns were used to write a test pattern from an AutoCAD file without thermal degradation of the surrounding regions.

This example shows that a diethylene glycol bis (allyl carbonate) polymer can be laser ablated to form microchannels. A diethylene glycol bis(allyl carbonate) polymer, on which microchannels can be formed, can thus be used as a microfluidic device.

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

I claim:

1. An electrokinetic device fabricated from a polyol (allyl carbonate) polymer.

2. The electrokinetic device of claim 1, wherein said device is used for Capillary electrophoresis, Capillary Zone electrophoresis, Free Zone electrophoresis, Micellar Electrokinetic Capillary Chromatography, Affinity capillary electrophoresis, Capillary isoelectric focusing, Isotachophoresis, Capillary Gel Electrophoresis, Capillary Electrochromatography, Electrokinetic Chromatography, Nonaqueous Capillary Chromatography, or Dielectrophoresis.

3. The electrokinetic device of claim 1, wherein said polyol (allyl carbonate) polymer is diethylene glycol bis(allyl carbonate) or a copolymer comprising greater than about 10% diethylene glycol bis(allyl carbonate).

4. The electrokinetic device of claim 1, wherein said polymer is generated by polymerizing a prepolymer of polyol (allyl carbonate).

5. The electrokinetic device of claim 1, wherein the chemical properties of said polyol (allyl carbonate) polymer are modified by hydrolysis.

6. The electrokinetic device of claim 1, wherein the chemical properties of said polyol (allyl carbonate) polymer are modified by attachment of a ligand.

7. A two-dimensional electrophoresis system for separating components within a sample, comprising
(a) an electrophoresis plate assembly that defines:
(i) a first electrophoresis region adapted to perform Micellar Electrokinetic Capillary Chromatography, Affinity capillary electrophoresis, Capillary isoelectric focusing, Isotachophoresis, Capillary Gel Electrophoresis, Capillary Electrochromatography, Electrokinetic Chromatography, Nonaqueous Capillary Chromatography, or Dielectrophoresis.
(ii) a second electrophoresis region, abutting the first electrophoresis region, adapted to perform Capillary electrophoresis, Capillary Zone electrophoresis, Free Zone electrophoresis, Micellar Electrokinetic Capillary Chromatography, Affinity capillary electrophoresis, Capillary isoelectric focusing, Isotachophoresis, Capillary Electrochromatography, Electrokinetic Chromatography, Nonaqueous Capillary Chromatography, or Dielectrophoresis in a second dimension, in a direction substantially perpendicular to said first dimension, containing a plurality of elongated separation microchannels
(iii) a sample loading port in fluid communication with said first region, for introducing a sample into said first electrophoresis region.
(b) electrode means for generating a first voltage potential across the first electrophoresis region, and
(c) electrode means for generating a second voltage potential across said the second electrophoresis region.

8. The system of claim 7, wherein said system is such that migration of sample components in the second dimension depend on sample properties that are different from the sample properties that determine sample migration in the first dimension.

9. The system of claim 7, wherein said two-dimensional electrophoresis system is constructed from a polyol (allyl carbonate) polymer.

10. The system of claim 9, wherein said polyol (allyl carbonate) polymer is diethylene glycol bis(allyl carbonate) or a copolymer comprising greater than about 10% diethylene glycol bis(allyl carbonate).

11. The system of claim 9, wherein said polymer is generated by polymerizing a prepolymer of polyol (allyl carbonate).

12. The system of claim 7, where said second region contains two or more microchannels.

13. The system of claim 7, where said two-dimensional electrophoresis system incorporates electrodes for the detection of said components within a sample.

14. A two-dimensional method for separating one or more components of a sample mixture by planar isoelectric focusing, said method comprising
(a) providing an electrophoresis plate assembly defining a planar sample separation cavity, bounded by opposing major first and second plate surfaces, which includes:
(i) a first electrophoresis region adapted to perform Micellar Electrokinetic Capillary Chromatography, Affinity capillary electrophoresis, Capillary isoelectric focusing, Isotachophoresis, Capillary Electrochromatography, Electrokinetic Chromatography, Nonaqueous Capillary Chromatography, or Dielectrophoresis.
(ii) a second electrophoresis region, abutting the first electrophoresis region, adapted to perform Capillary electrophoresis, Capillary Zone electrophoresis, Free Zone electrophoresis, Micellar Electrokinetic Capillary Chromatography, Affinity capillary electrophoresis, Capillary isoelectric focusing, Isotachophoresis, Capillary Gel Electrophoresis, Capillary Electrochromatography, Electrokinetic Chromatography, Nonaqueous Capillary Chromatography, or Dielectrophoresis in a second dimension, in a direction substantially perpendicular to said first dimension, containing a plurality of elongated separation microchannels
(iii) a sample loading port in fluid communication with said first region, for introducing a sample into said first electrophoresis region.
(b) applying a sample mixture to said sample loading port
(c) applying a first voltage potential across the first region, under conditions effective to cause said sample components to migrate across the region, such that different components become separated as a result of some characteristic other than size
(d) applying a second voltage potential across the second region, such that said migrated sample components migrate into the second region, in a direction substantially perpendicular to said first dimension, and become separated on the basis of some characteristic other than the basis for separation in said first region.

15. The method of claim 14, wherein the sample components are polypeptides.

16. The method of claim 14, further comprising detecting the separated sample components following step (d).

17. The method of claim 14, further comprising collecting at least one of the separated sample components following step (d).

18. The method of claim 14, further comprising analyzing at least one of the separated sample components following step (d) by mass spectroscopy.

19. A sensor for the detection of chemical or biochemical components in liquid or gas comprising:
(a) at least a pair of electrodes in a sample microchannel
(b) at least a pair of electrodes in a reference microchannel
(c) a means for producing a electric field across the electrodes
(d) a means of comparing the electrical resistance, impedance, current, phase, conductivity, voltage, or other electrical parameter between said electrodes in a sample microchannel and electrodes in a reference microchannel.

20. A sensor of claim 19, where said electric field is a DC current.

21. A sensor of claim 19, where said electric field is a modulated DC current.

22. A sensor of claim 19, where said electric field is an AC current.

23. A sensor of claim 19, where said means of comparing is a potentiometer.

24. A sensor of claim 19, where said means of comparing is with a Wheatstone Bridge.

25. A sensor of claim 19, where said electrodes in a sample microchannel and said electrodes in a reference microchannel form two resistive elements of a Wheatstone Bridge.

26. A sensor of claim 19, where said means of comparing is through changes in sound frequency.

27. A sensor of claim 19, where said means of comparing is with a microammeter.

28. A method of detecting chemical and biochemical components consisting of
(a) orienting at least a pair of electrodes in a sample microchannel
(b) orienting at least a pair of electrodes in a reference microchannel
(c) generating an electric field across the electrodes
(d) introducing a sample into the sample microchannel
(e) comparing the electrical resistance, impedance, current, phase, conductivity, voltage, or other electrical parameter between said electrodes in a sample microchannel and said electrodes in reference microchannel.
